(19) United States
(12) Patent Application Publication
(10) Pub. No.: US 2026/0257687 A1
(43) Pub. Date: Sep. 3, 2026

(54) PROCESSING SYSTEM, PROCESSING METHOD, AND NON-TRANSITORY COMPUTER-READABLE MEDIUM

(71) Applicant: NEC Corporation, Tokyo (JP)

(72) Inventors: Yasuhiro MIZUKOSHI, Tokyo (JP); Yoshihiro MISHIMA, Tokyo (JP); Noritaka YAMASHITA, Tokyo (JP); Asako FUJII, Tokyo (JP)

(73) Assignee: NEC Corporation, Tokyo (JP)

(21) Appl. No.: 19/158,078

(22) PCT Filed: Feb. 27, 2023
(86) PCT No.: PCT/JP2023/007048

§ 371 Date: Aug. 20, 2025

(51) Int. Cl. B60W 50/00

(52) U.S. Cl. CPC B60W 50/0098; B60W 2420/403; B60W 2540/221

(57) ABSTRACT

The present invention provides a processing system (10) detects a suspension event, which involves suspension of the use of a vehicle, on the basis of a sensor mounted on the vehicle; registers, as a reference value, a CO₂ concentration of the inside of the vehicle at the time of detection of the suspension event; detects an alighting event, which involves alighting from the vehicle, on the basis of the sensor mounted on the vehicle; in the case where the alighting event is detected after the suspension event, updates the registered reference value to a CO₂ concentration of the inside of the vehicle at the time of detection of the alighting event; and detects a living object left behind in the vehicle through a comparison between the reference value and a CO₂ concentration of the inside of the vehicle after the detection of the suspension event.

### TECHNICAL FIELD

The present invention relates to a processing system, a processing method, and a recording medium.

### BACKGROUND ART

Techniques related to the present invention are disclosed in PTLs 1 to 3.

The technique disclosed in PTL 1 determines that a vehicle is in a parked state in a case where an engine is in an off state, there is no driver in the vehicle, and all doors are in a closed state, and detects a living object left behind in the vehicle based on a CO₂ concentration inside the vehicle in that state.

The technique disclosed in PTL 2 determines that a vehicle is in a parked state in a case where an ignition switch of the vehicle is in an off state, and detects a living object left behind in the vehicle based on a CO₂ concentration inside the vehicle in the parked state.

The technique disclosed in PTL 3 determines that the vehicle is in a parked state in a case where the engine of the vehicle is in an off state, and detects a living object left behind in the vehicle based on the CO₂ concentration inside the vehicle in the parked state.

### CITATION LIST

### Patent Literature

PTL 1: WO 2021/090892 A1
PTL 2: JP 2020-201108 A
PTL 3: JP 2019-168858 A

### SUMMARY OF INVENTION

### Technical Problem

As an example of means for detecting a living object left behind in the vehicle based on the CO₂ concentration inside the vehicle detected by the sensor, the following method can be considered. In this method, the CO₂ concentration inside the vehicle at the time a suspension event which involves suspension of the use of the vehicle is detected (for example, at the time the parked state disclosed in PTLs 1 to 3 is detected) is the reference value. Then, in a case where a value obtained by subtracting the reference value from the CO₂ concentration inside the vehicle thereafter (an increased value of the CO₂ concentration) exceeds a threshold, it is determined that a living object is left behind in the vehicle.

The present inventor has found the following problems in the method. The CO₂ concentration inside the vehicle after the suspension event which involves suspension of the use of the vehicle is detected may increase due to a factor other than a living object left behind in the vehicle. For example, there is a case where an occupant intentionally continues to stay in the vehicle after the suspension event is detected, and then alights from the vehicle. The length of time from the detection of the suspension event to the abandonment varies. Since the occupant intentionally continues to stay in the vehicle, the occupant is not relevant to the abandonment.

As in this example, after the suspension event which involves suspension of the use of the vehicle is detected, the CO₂ concentration inside the vehicle may increase due to factors other than a living object left behind in the vehicle. If the abandonment of the living object in the vehicle is not determined based on an appropriate reference value, an erroneous determination result may be obtained. None of PTLs 1 to 3 describes or suggests the problem and the solution thereof.

In view of the above-described problems, an object of the present invention is to provide a processing system, a processing method, and a recording medium that solve a problem of suppressing erroneous determination in detection of a living object left behind in a vehicle based on a CO₂ concentration inside the vehicle.

### Solution to Problem

According to one example aspect of the present invention, there is provided a processing system including:
a suspension detection means for detecting a suspension event, which involves suspension of a use of a vehicle, based on a sensor mounted on the vehicle;
a reference value registration means for registering, as a reference value, a CO₂concentration of an inside of the vehicle at a time of detection of the suspension event;
an alighting detection means for detecting an alighting event, which involves alighting from the vehicle, based on a sensor mounted on the vehicle;
a reference value updating means for, in a case where the alighting event is detected after the suspension event, updating the registered reference value to a CO₂ concentration of an inside of the vehicle at a time of detection of the alighting event; and
an abandonment detection means for detecting a living object left behind in the vehicle by comparing the reference value with a CO₂ concentration of an inside of the vehicle after the suspension event is detected.

According to one example aspect of the present invention, there is provided a processing method including:
detecting a suspension event, which involves suspension of a use of a vehicle, based on a sensor mounted on the vehicle;
registering, as a reference value, a CO₂ concentration of an inside of the vehicle at a time of detection of the suspension event;
an alighting detection means for detecting an alighting event, which involves alighting from the vehicle, based on a sensor mounted on the vehicle;
updating, in a case where the alighting event is detected after the suspension event, the registered reference value to a CO₂ concentration of an inside of the vehicle at a time of detection of the alighting event; and
detecting a living object left behind in the vehicle by comparing the reference value with a CO₂ concentration of an inside of the vehicle after the suspension event is detected.

According to one example aspect of the present invention, there is provided a recording medium storing a program causing a computer to function as:
a suspension detection means for detecting a suspension event, which involves suspension of a use of a vehicle, based on a sensor mounted on the vehicle;
a reference value registration means for registering, as a reference value, a CO₂ concentration of an inside of the vehicle at a time of detection of the suspension event;
an alighting detection means for detecting an alighting event, which involves alighting from the vehicle, based on a sensor mounted on the vehicle;
a reference value updating means for, in a case where the alighting event is detected after the suspension event, updates the registered reference value to a CO₂ concentration of an inside of the vehicle at a time of detection of the alighting event; and
an abandonment detection means for detects a living object left behind in the vehicle by comparing the reference value with a CO₂ concentration of an inside of the vehicle after the suspension event is detected.

### ADVANTAGEOUS EFFECTS OF INVENTION

According to one example aspect of the present invention, a processing system, a processing method, and a recording medium that solve a problem of suppressing erroneous determination in detection of a living object left behind in a vehicle based on a CO₂ concentration inside the vehicle are implemented.

### BRIEF DESCRIPTION OF DRAWINGS

The above-described object and other objects, features, and advantages will be further clarified by the following suitable example embodiments and accompanying drawings.

FIG. 1 It is a diagram illustrating an example of a functional block diagram of a processing system.

FIG. 2 It is a diagram illustrating another example of a functional block diagram of the processing system.

FIG. 3 It is a diagram for explaining an example of processing of detecting a living object left behind in a vehicle.

FIG. 4 It is a diagram for explaining a problem that can occur in an example of processing of detecting a living object left behind in a vehicle.

FIG. 5 It is a diagram for explaining another example of processing of detecting a living object left behind in a vehicle.

FIG. 6 It is a diagram illustrating an example of an overall image of a system including a processing system.

FIG. 7 It is a diagram illustrating an example of a hardware configuration of an information system.

FIG. 8 It is a diagram schematically illustrating an example of information processed by the information system.

FIG. 9 It is a flowchart illustrating an example of a processing flow of the processing system.

FIG. 10 It is a flowchart illustrating another example of a processing flow of the processing system.

FIG. 11 It is a flowchart illustrating another example of a processing flow of the processing system.

FIG. 12 It is a flowchart illustrating another example of a processing flow of the processing system.

FIG. 13 It is a flowchart illustrating another example of a processing flow of the processing system.

FIG. 14 It is a diagram illustrating another example of a functional block diagram of the processing system.

FIG. 15 It is a diagram schematically illustrating another example of information processed by the information system.

FIG. 16 It is a diagram illustrating another example of an overall image of a system including the processing system.

FIG. 17 It is a diagram illustrating another example of an overall image of a system including the processing system.

FIG. 18 It is a diagram illustrating another example of an overall image of a system including the processing system.

### EXAMPLE EMBODIMENT

Hereinafter, example embodiments of the present invention will be described with reference to the drawings. In all the drawings, similar components are denoted by similar reference numerals, and the description thereof will be omitted as appropriate.

### First Example Embodiment

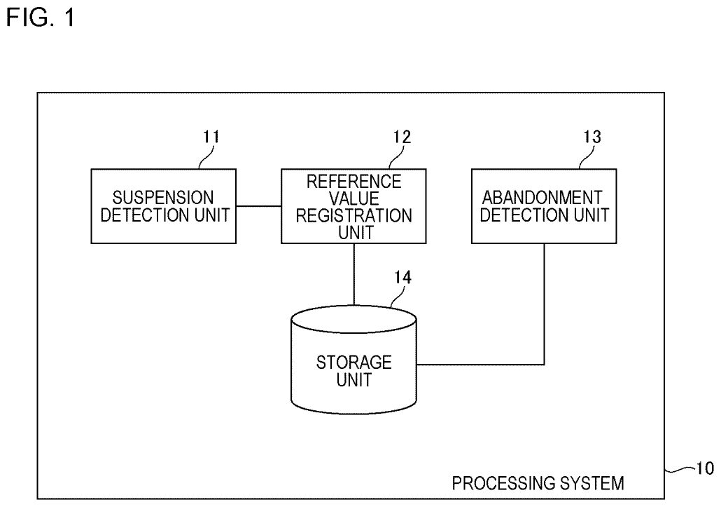

FIG. 1 is a functional block diagram illustrating an outline of a processing system 10 according to a first example embodiment. The processing system 10 includes a suspension detection unit 11, a reference value registration unit 12, an abandonment detection unit 13, and a storage unit 14. The processing system 10 may not include the storage unit 14. In this case, an external device configured to be able to communicate with the processing system 10 includes the storage unit 14.

The suspension detection unit 11 acquires parking position information indicating a parking position of the vehicle. Then, the suspension detection unit 11 detects the suspension event which involves suspension of the use of the vehicle by comparing the position indicated by the parking position information with the registration area registered in advance. The reference value registration unit 12 registers the CO₂ concentration inside the vehicle at the time the suspension event is detected in the storage unit 14 as a reference value. The abandonment detection unit 13 detects a living object left behind in the vehicle by comparing the CO₂ concentration inside the vehicle after the suspension event is detected with the reference value registration united in the storage unit 14.

As described above, the processing system 10 detects the suspension event which involves suspension of the use of the vehicle by comparing the parking position of the vehicle with the registration area registered in advance. Specifically, “the parking position of the vehicle is within the registration area” is a condition for detecting a suspension event. Then, the processing system 10 detects a living object left behind in the vehicle based on the CO₂ concentration inside the vehicle after the suspension event is detected.

According to such a processing system 10, processing of detecting a living object left behind in the vehicle is executed only in a case where the vehicle is parked in a registration area registered in advance. By appropriately registering the registration area, it is possible to execute processing of detecting a living object left behind in the vehicle at an appropriate timing and to suppress inconvenience of executing the processing at an unnecessary timing. For example, a parking lot of a facility such as a parking lot that is usually used or a shopping mall that tends to park for a relatively long time can be registered as the registration area. At the time of taking a child to or from a cram school or a lesson, a user who may suspend the vehicle near the location and wait in the vehicle until the child comes out may not register the position as a registration area.

According to the processing system 10 of the present example embodiment, the problem of executing the processing of detecting a living object left behind in the vehicle at an appropriate timing is solved.

### Second Example Embodiment

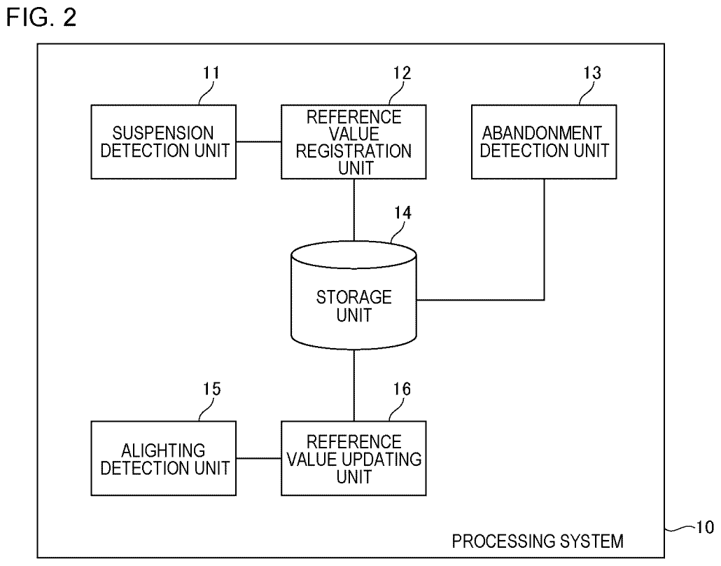

FIG. 2 is a functional block diagram illustrating an outline of a processing system 10 according to a second example embodiment. The processing system 10 includes a suspension detection unit 11, a reference value registration unit 12, an abandonment detection unit 13, a storage unit 14, an alighting detection unit 15, and a reference value updating unit 16. The processing system 10 may not include the storage unit 14. In this case, an external device configured to be able to communicate with the processing system 10 includes the storage unit 14.

The suspension detection unit 11 detects a suspension event which involves suspension of the use of the vehicle based on a sensor mounted on the vehicle. The reference value registration unit 12 registers the CO₂ concentration inside the vehicle at the time the suspension event is detected in the storage unit 14 as a reference value. The alighting detection unit 15 detects an alighting event which involves alighting from the vehicle based on a sensor mounted on the vehicle. In a case where an alighting event is detected after the suspension event, the reference value updating unit 16 updates the reference value registration united in the storage unit 14 to the CO₂ concentration inside the vehicle at the time the alighting event is detected.

The abandonment detection unit 13 detects a living object left behind in the vehicle by comparing the CO₂ concentration inside the vehicle after the suspension event is detected with the reference value registration united in the storage unit 14.

In this manner, the processing system 10 registers the CO₂ concentration inside the vehicle at that time as a reference value in response to the detection of the suspension event, and updates the reference value to the CO₂ concentration inside the vehicle at that time in response to the subsequent detection of the alighting event. Then, the processing system 10 detects a living object left behind in the vehicle based on the latest reference value. By updating the reference value by such a method and detecting a living object left behind in the vehicle based on the reference value, it is possible to suppress erroneous detection. The reason will be described below.

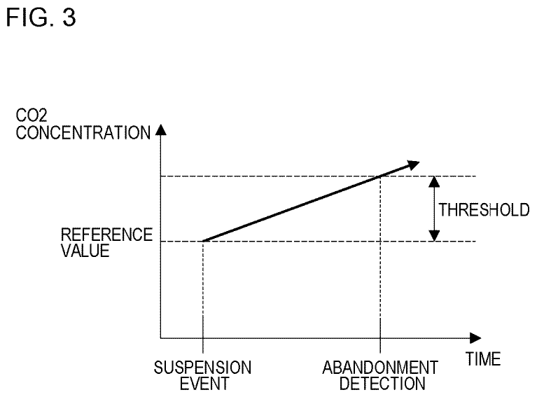

As an example of means for detecting a living object left behind in the vehicle based on the CO₂ concentration inside the vehicle detected by the sensor, the method illustrated in FIG. 3 can be considered. In FIG. 3, the horizontal axis represents time, and the vertical axis represents the CO₂ concentration inside the vehicle.

In this method, the CO₂ concentration inside the vehicle at the time a suspension event which involves suspension of the use of the vehicle is detected is the reference value. Then, in a case where a value obtained by subtracting the reference value from the CO₂ concentration inside the vehicle thereafter (an increased value of the CO₂ concentration) exceeds a threshold, it is determined that a living object is left behind in the vehicle.

In this method, there is a possibility that it is erroneously determined that a living object is left in the vehicle in the following case.

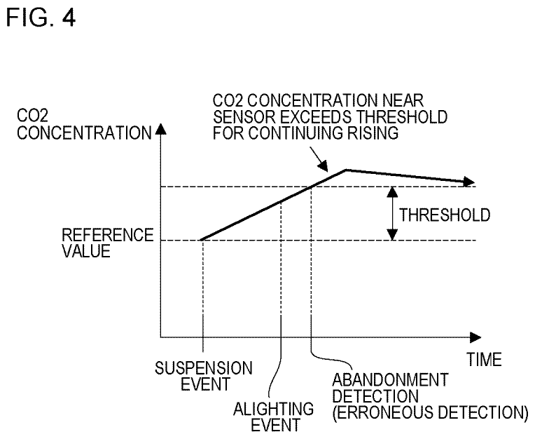

The case is a case where, after a suspension event is detected, an occupant intentionally continues to stay in the vehicle in a state where a door or a window is closed, and then alights from the vehicle, and there is no living object in the vehicle. The reason why erroneous determination occurs in such a case will be described with reference to FIG. 4.

FIG. 4 illustrates a flow in which the occupant alights from the vehicle (illustrated “alighting event”) after the suspension event is detected. In this case, of course, even after the suspension event, the CO₂ concentration inside the vehicle detected by the sensor continues to increase due to the occupant who intentionally continues to stay inside the vehicle. Then, in a case where the occupant alights from the vehicle, the increase in the CO₂ concentration inside the vehicle detected by the sensor stops. However, as illustrated in FIG. 4, there is a possibility that the increase does not stop immediately in response to the abandonment of the occupant, but the increase stops after a while after the abandonment. This phenomenon is caused by the size of the vehicle, the deviation of the CO₂ concentration inside the vehicle, the mounting position of the sensor, and the like.

FIG. 4 illustrates a case where the CO₂ concentration inside the vehicle increases to some extent due to the occupant intentionally continuing to stay in the vehicle after the suspension event is detected, and then the CO₂ concentration inside the vehicle continues to increase for a while after the occupant alights from the vehicle. As illustrated in FIG. 4, due to the increase in the CO₂ concentration inside the vehicle after the occupant alights from the vehicle, a value obtained by subtracting the reference value from the CO₂ concentration inside the vehicle detected by the sensor exceeds the threshold, and it can be erroneously determined that the living object is left in the vehicle.

It is also conceivable to stop the detection of the abandonment based on the CO₂ concentration inside the vehicle in response to the alighting event. However, in the case of this method, in a case where another living object is left in the vehicle after the alighting event, the abandonment cannot be detected.

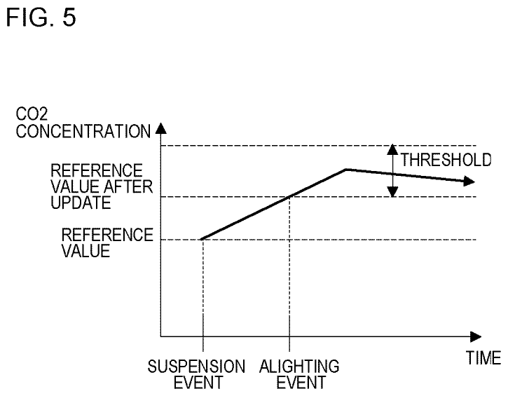

To solve this problem, as illustrated in FIG. 5, the processing system 10 of the present example embodiment registers the CO₂ concentration inside the vehicle at that time as a reference value in response to detection of a suspension event, and updates the reference value to the CO₂ concentration inside the vehicle at that time in response to detection of a subsequent alighting event. Then, after the alighting event is detected, the processing system 10 determines that a living object is left in the vehicle at the time a value obtained by subtracting the updated reference value from the CO₂ concentration inside the vehicle (an increased value of the CO₂ concentration) exceeds a threshold. According to such a processing system 10, as illustrated in FIG. 5, even if the CO₂ concentration inside the vehicle continues to increase for a while after the occupant alights from the vehicle, it is possible to suppress an inconvenience that a value obtained by subtracting the reference value from the CO₂ concentration inside the vehicle detected by the sensor due to the increase during the period exceeds the threshold.

As described above, according to the processing system 10 of the present example embodiment, the problem of suppressing erroneous determination in the detection of a living object left behind in the vehicle based on the CO₂ concentration inside the vehicle is solved.

### Third Example Embodiment

### Overview

The processing system 10 of a third example embodiment is obtained by embodying the processing system 10 of the first example embodiment. That is, the processing system 10 detects the suspension event which involves suspension of the use of the vehicle by comparing the parking position of the vehicle with the registration area registered in advance. Then, the processing system 10 detects a living object left behind in the vehicle based on the CO₂ concentration inside the vehicle after the suspension event is detected. Details will be described below.

### Overall Image

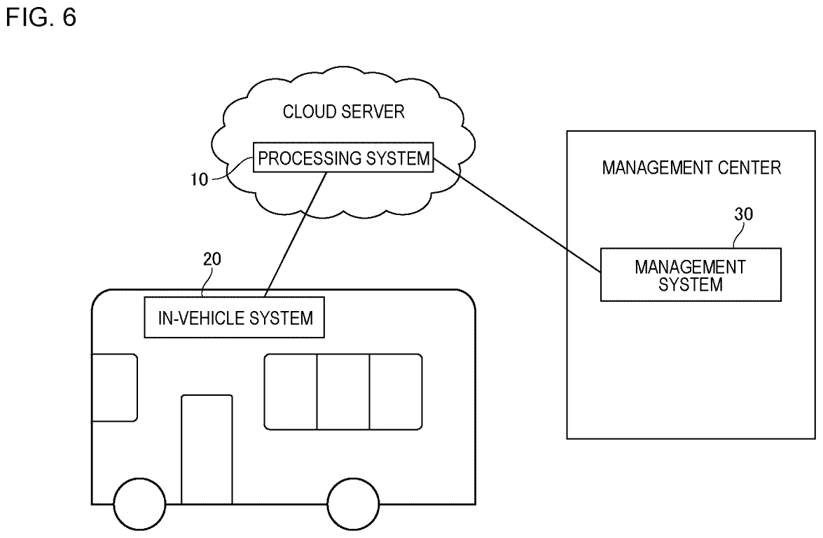

FIG. 6 illustrates an overall image of a system included in the processing system 10. As illustrated, the processing system 10 executes predetermined processing in cooperation with an in-vehicle system 20 and a management system 30.

The in-vehicle system 20 is a system mounted on a vehicle. The vehicle is a bus, a passenger car, a truck, a train, or the like, but is not limited thereto. The vehicle may be a vehicle driven by a person. The vehicle may be an automatic driving vehicle.

The in-vehicle system 20 includes at least various sensors mounted at arbitrary positions of the vehicle, and means for collecting measurement values measured by the various sensors and information indicating the state of the vehicle and transmitting the information to the processing system 10. Examples of the state of the vehicle include, but are not limited to, an engine state (ON/OFF), a power supply state (ON/OFF), a door lock state (open/closed), and the like. The in-vehicle system 20 can include an electronic control unit (ECU). Signals from various sensors and switches are input to the ECU.

Examples of the various sensors include a CO₂ sensor that measures a CO₂ concentration, a temperature sensor that measures a temperature, a camera (image sensor) that captures an image, and a door sensor that detects opening/closing of a door of a vehicle. In addition, examples of the various sensors include a weight sensor for detecting that a person is sitting on a seat, a position sensor (global positioning system (GPS) sensor) for measuring a current position of the vehicle, and the like. The various sensors are not limited to those exemplified here.

The processing system 10 detects a suspension event which involves suspension of the use of the vehicle based on the information received from the in-vehicle system 20. Then, the processing system 10 detects a living object left behind in the vehicle based on the CO₂ concentration inside the vehicle after the suspension event is detected. The processing system 10 transmits various calculation results to the management system 30. A specific configuration of the processing system 10 will be described later.

The management system 30 is a system installed in a management center. The management system 30 outputs the information received from the processing system 10 via various output devices. The output device is a display, a speaker, a projection device, a printer, or the like, but is not limited thereto.

A surveillance staff is resident in the management center and monitors information output by the management system 30. For example, in a case where abandonment in a certain vehicle is detected by the processing system 10, information indicating the detection is output from the management system 30. The output information may include the position information of the vehicle in which the abandonment is detected, the date and time at the time the abandonment is detected, the elapsed time from the detection of the suspension event, the current state of the inside of the vehicle (CO₂ concentration, temperature, etc.), and the like. The surveillance staff can take an appropriate response based on such information. Examples of the response include, but are not limited to, contact with a contact address (telephone number, email address, etc.) registered in advance in association with the vehicle, dispatch of a worker to the position of the vehicle, and the like.

### Hardware Configuration

An example of a hardware configuration of the processing system 10 will be described. Each functional unit of the processing system 10 is implemented by an arbitrary combination of hardware and software. It is to be understood by those skilled in the art that there are various modifications of the implementation method and device. The software includes a program stored in advance from a stage of shipping the device, a program downloaded from a recording medium such as a compact disc (CD), a server on the Internet, or the like.

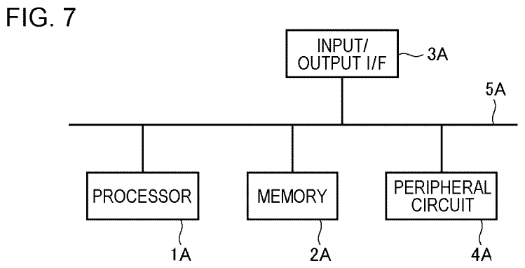

FIG. 7 is a block diagram illustrating a hardware configuration of the processing system 10. As illustrated in FIG. 7, the processing system 10 includes a processor 1A, a memory 2A, an input/output interface 3A, a peripheral circuit 4A, and a bus 5A. The peripheral circuit 4A includes various modules. The processing system 10 may not include the peripheral circuit 4A. The processing system 10 may include a plurality of physically and/or logically separated devices. In this case, each of the plurality of devices can have the above-described hardware configuration.

The bus 5A is a data transmission path through which the processor 1A, the memory 2A, the peripheral circuit 4A, and the input/output interface 3A mutually transmit and receive data. The processor 1A is an arithmetic processing unit such as a CPU or a graphics processing unit (GPU). The memory 2A is, for example, a memory such as a random access memory (RAM) or a read only memory (ROM). The input/output interface 3A includes an interface for acquiring information from an input device, an external device, an external server, an external sensor, a camera, and the like, an interface for outputting information to an output device, an external device, an external server, and the like. The input/output interface 3A includes an interface for connecting to a communication network such as the Internet. The input device is, for example, a keyboard, a mouse, a microphone, a physical button, a touch panel, or the like. The output device is, for example, a display, a speaker, a printer, a mailer, or the like. The processor 1A can issue a command to each module and perform calculation based on the calculation results.

### Functional Configuration

Next, a functional configuration of the processing system 10 of the present example embodiment will be described in detail. FIG. 1 illustrates an example of a functional block diagram of the processing system 10. As illustrated, the processing system 10 includes a suspension detection unit 11, a reference value registration unit 12, an abandonment detection unit 13, and a storage unit 14. The processing system 10 may not include the storage unit 14. In this case, an external device configured to be able to communicate with the processing system 10 includes the storage unit 14.

The suspension detection unit 11 acquires parking position information indicating a parking position of the vehicle. Then, the suspension detection unit 11 detects the suspension event which involves suspension of the use of the vehicle by comparing the position indicated by the parking position information with the registration area registered in advance. Hereinafter, a process of acquiring suspension position information and a process of detecting a suspension event will be described separately.

### Acquisition of Parking Position Information

The “parking position information” is information indicating the position of the vehicle at the time the parking-related event is detected. The parking position information is vehicle position information (GPS information or the like) acquired at the position of the vehicle at the time the parking-related event is detected.

The “parking-related event” includes at least one of the following.
Engine stop process of vehicle
Power off process of vehicle
Door lock process based on predetermined locking operation for locking door of vehicle from outside of vehicle
Event in which position of vehicle does not change for predetermined time or more
Absence of person in driver's seat

The “engine stop process of the vehicle” is a process of switching the engine of the vehicle from ON to OFF. The processes can be detected based on the information handled by the in-vehicle system 20.

The “power off process of the vehicle” is a process of switching the power of the vehicle from ON to OFF. The processes can be detected based on the information handled by the in-vehicle system 20.

The “door lock process based on a predetermined locking operation for locking the door of the vehicle from the outside of the vehicle” is a process of locking the door based on an operation on a smart key, a sensor present outside the vehicle (for example, a door knob portion), or the like. The processes can be detected based on the information handled by the in-vehicle system 20. For example, information for identifying an input method (examples: inputs from smart keys, inputs from sensors present outside the vehicle) may be included in data input to the system.

The “event in which the position of the vehicle does not change for a predetermined time or more” is detected based on the current position of the vehicle detected by a position sensor mounted on the vehicle. The predetermined time is a predetermined value.

The “absence of a person in the driver's seat” is detected based on an image generated by a weight sensor for detecting that a person is seated in the driver's seat or a camera that photographs the driver's seat. For example, in a case where the weight detected by the weight sensor is equal to or less than the threshold, it is determined that there is no person in the driver's seat. In a case where no person is shown in a predetermined area (an area where the driver's seat is present) defined in advance in the image generated by the camera, it is determined that no person is present in the driver's seat.

The suspension detection unit 11 acquires parking position information indicating the position of the vehicle at the time the above-described parking-related event is detected. The detection of the parking-related event may be performed by the suspension detection unit 11.

That is, the suspension detection unit 11 may acquire various types of information for detecting the parking-related event as described above from the in-vehicle system 20 in real-time processing, and detect the parking-related event based on the acquired information. In addition, the in-vehicle system 20 may detect the parking-related event. Then, the detection result may be transmitted from the in-vehicle system 20 to the processing system 10.

### Detection of Suspension Event

In a case where the position indicated by the parking position information is included in the registration area registered in advance, the suspension detection unit 11 determines that a suspension event which involves suspension of the use of the vehicle has occurred (detection of the suspension event). In the present example embodiment, the above-described “detection of a parking-related event” and “the position indicated by the parking position information is included in the registration area registered in advance” are conditions for detection of a suspension event. The suspension event is an event that triggers processing executed by the reference value registration unit 12 or the abandonment detection unit 13.

There are various methods for registering the registration area. For example, the registration area is registered by at least one of the following first to third registration methods.

### First Registration Method

In the first registration method, a registration area is registered for each vehicle. Specifically, the suspension detection unit 11 registers the registration area for each vehicle based on the user input.

The user input may be, for example, an address input. In this case, the area relevant to the address is registered as the registration area. The address to be input may include a lot address such as “1-2-3, xxx town, xxx city, xxx prefecture”. In addition, the address to be input may specify up to a prefecture or a municipality without including a lot address, such as “○○ prefecture”, “○○ city in ○○ prefecture”, and “○○ town in ○○ city in ○○ prefecture”. An area specified by the input information is registered as a registration area.

In addition, the user input may be an input for designating a predetermined point on the map. In this case, a predetermined area specified based on the designated point is registered as the registration area. For example, the suspension detection unit 11 may register a circle with a radius R [m] centered on the designated point as the registration area. The value of the radius R may be freely set by the user or may be determined in advance.

The process of receiving the user input and registering the registration point as described above for each vehicle is implemented using any technology. For example, use of an application or a web page is exemplified, but the present invention is not limited thereto.

### Second Registration Method

In the second registration method, a registration area is registered for each vehicle. Specifically, the suspension detection unit 11 registers the registration area for each vehicle based on the history of the past positions for each vehicle.

In the case of the method, as a premise, a history of past positions for each vehicle is registered. The history is registered by processing of repeatedly acquiring and registering the current position of the vehicle by the GPS sensor mounted on the vehicle.

The suspension detection unit 11 registers, as a registration area, a position where a person has continuously stayed for a predetermined time or more in the past. In addition, the suspension detection unit 11 may register, as the registration area, a position where a person has continuously stayed for a predetermined time or more in a state where a person is absent in the driver's seat in the past. As described above, the absence of the person in the driver's seat can be identified based on, for example, the weight sensor or the image generated by the camera that captures the driver's seat.

For example, the suspension detection unit 11 may register, as the registration area, a predetermined area specified based on a point where a person has continuously stayed for a predetermined time or more in the past or a point where a person has continuously stayed for a predetermined time or more in a state where a person is absent in the driver's seat in the past.

Specifically, the suspension detection unit 11 may register a circle with a radius R [m] centered on the point as the registration area. The value of the radius R may be freely set by the user or may be determined in advance. The predetermined time may be a predetermined fixed value. The predetermined time may be freely changed by the user.

### Third Registration Method

In the third registration method, a registration area commonly applied to all vehicles is registered. In the third registration method, for example, a facility that is visited by an unspecified large number of people such as a shopping mall or an amusement park and tends to have a relatively long stay time (parking time) is registered as a registration area.

For example, these facilities are registered as registration areas by inputs of an operator or an administrator of the processing system 10. The registration method is similar to the first registration method.

In a case of detecting a suspension event in a certain vehicle (target vehicle), the suspension detection unit 11 determines whether a position indicated by parking position information acquired in relation to the target vehicle is in a registration area registered in association with the target vehicle. The suspension detection unit 11 may determine whether the position indicated by the parking position information acquired in relation to the target vehicle is in the registration area commonly applied to all the vehicles.

Then, in a case of determining that the position indicated by the parking position information acquired in relation to the target vehicle is within the registration area, the suspension detection unit 11 determines that a suspension event which involves suspension of the use of the vehicle has occurred in the target vehicle.

In a case of determining that the position indicated by the parking position information acquired in relation to the target vehicle is not in the registration area, the suspension detection unit 11 does not determine that a suspension event which involves suspension of the use of the vehicle has occurred in the target vehicle.

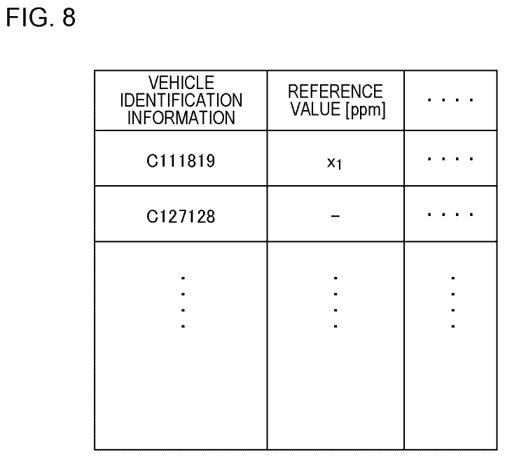

Returning to FIG. 1, the reference value registration unit 12 registers the CO₂ concentration inside the vehicle at the time the suspension event is detected as a reference value in the storage unit 14. FIG. 8 schematically illustrates an example of information stored in the storage unit 14. In the illustrated example, the vehicle identification information and the reference value are registered in association with each other. As described above, a CO₂ sensor that measures a CO₂ concentration is mounted on the vehicle. The CO₂ sensor measures the CO₂ concentration inside the vehicle at the time a suspension event is detected.

The abandonment detection unit 13 detects a living object left behind in the vehicle by comparing the CO₂ concentration inside the vehicle after the suspension event is detected with the reference value registration registered in the storage unit 14. The living object includes humans and other animals (dog, cat, etc.).

Specifically, as illustrated in FIG. 3, the abandonment detection unit 13 determines that a living object is left behind in the vehicle in a case where a value obtained by subtracting a reference value from the CO₂ concentration inside the vehicle after the suspension event is detected (an increased value of the CO₂ concentration) exceeds a threshold. The threshold is a predetermined value. In the following example embodiment, means for setting the threshold for each vehicle will be described.

The abandonment detection unit 13 can perform a predetermined warning process in a case of detecting a living object left behind in the vehicle.

For example, the abandonment detection unit 13 may transmit information indicating the fact to the management system 30. The information transmitted to the management system 30 may include the position information of the vehicle in which the abandonment is detected, the date and time in which the abandonment is detected, the elapsed time from the detection of the suspension event, the current state inside the vehicle (CO₂ concentration, temperature, etc.), and the like.

In addition, the abandonment detection unit 13 may notify a contact address registered in advance in association with each vehicle of the fact. The notification may be implemented by electronic mail, push notification of an application, or the like. The information notified by the notification may include the position information of the vehicle in which the abandonment is detected, the date and time at the time the abandonment is detected, the elapsed time from the detection of the suspension event, the current state of the inside of the vehicle (CO₂ concentration, temperature, etc.), and the like.

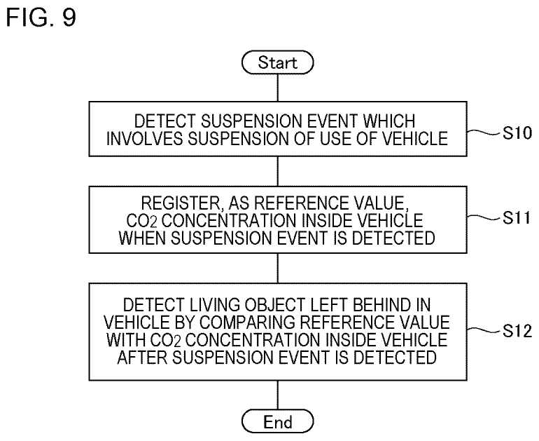

Next, an example of a processing flow of the processing system 10 will be described with reference to a flowchart of FIG. 9.

In a case of detecting a suspension event which involves suspension of the use of the vehicle (S10), the processing system 10 registers the CO₂ concentration inside the vehicle at the time the suspension event is detected as a reference value (S11).

Then, the processing system 10 detects a living object left behind in the vehicle by comparing the CO₂ concentration inside the vehicle after the suspension event is detected with the reference value (S12). Specifically, as illustrated in FIG. 3, in a case where a value obtained by subtracting the reference value from the CO₂ concentration inside the vehicle after the suspension event is detected (an increased value of the CO₂ concentration) exceeds a threshold, the processing system 10 determines that a living object is left behind in the vehicle. In a case where a living object left behind in the vehicle is not detected even after a predetermined time (predetermined value) has elapsed from the detection of the suspension event, the processing system 10 may end the process of detecting a living object left behind in the vehicle in S12. That is, in such a case, the processing system 10 may end the monitoring of the “Whether the value obtained by subtracting the reference value from the CO₂ concentration inside the vehicle after the suspension event is detected exceeds the threshold”.

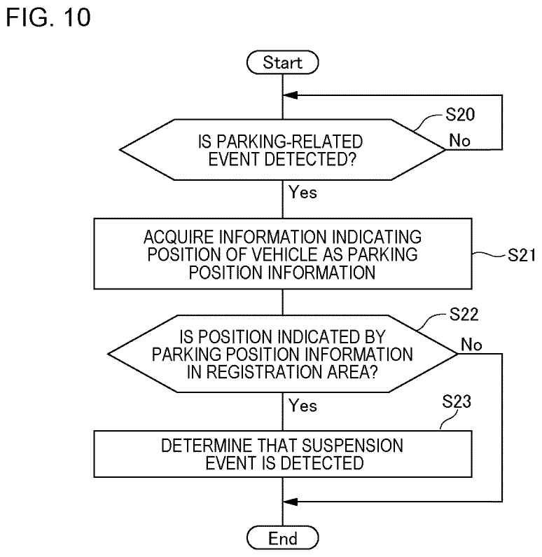

Here, an example of a processing flow of detecting a suspension event in S10 will be described with reference to the flowchart of FIG. 10.

In a case of detecting the parking-related event (Yes in S20), the processing system 10 acquires information indicating the position of the vehicle as parking position information (S21). The parking-related event includes at least one of an engine stop process of the vehicle, a power-off process of the vehicle, a door lock process based on a predetermined lock operation for locking a door of the vehicle from the outside of the vehicle, an event in which the position of the vehicle does not change for a predetermined time or more, and absence of a person in the driver's seat.

Then, in a case of determining that the position indicated by the parking position information is in the registration area registered in advance (Yes in S22), the processing system 10 determines that a suspension event which involves suspension of the use of the vehicle has occurred (S23). On the other hand, in a case of determining that the position indicated by the parking position information is not in the registration area registered in advance (No in S22), the processing system 10 does not determine that the suspension event which involves suspension of the use of the vehicle has occurred.

The processing system 10 of the present example embodiment may include means for updating the reference value described in the second example embodiment.

### Operation and Effect

According to the processing system 10 of the present example embodiment, operations and effects similar to those of the processing system 10 of the first and second example embodiments are achieved.

According to the processing system 10 of the present example embodiment, the above-described “detection of a parking-related event” and “the position indicated by the parking position information is included in the registration area registered in advance” can be set as conditions for the suspension event detection. By executing the process of detecting a living object left behind in the vehicle in a case where such a suspension event is detected, it is possible to suppress an inconvenience that the process is executed at an unnecessary timing.

According to the processing system 10 of the present example embodiment, the registration area can be registered by the above-described various methods.

For example, the processing system 10 can register the registration area for each vehicle based on the user input. The user can freely register a desired position as a registration area.

The processing system 10 can register the registration area for each vehicle based on the history of the past position for each vehicle. For example, a position where a person has continuously stayed for a predetermined time or more in the past, a position where a person has continuously stayed for a predetermined time or more in a state where a person is absent in the driver's seat in the past, or the like can be registered as the registration area. If the living object is left in the vehicle at such a position, it may be life-threatening to the living object. According to the processing system 10 of the present example embodiment, such an important position can be automatically registered for each vehicle.

The processing system 10 can register a registration area commonly applied to all vehicles. For example, a facility that is visited by an unspecified large number of people such as a shopping mall or an amusement park and tends to have a relatively long stay time (parking time) is registered as a registration area. If the living object is left in the vehicle at such a position, it may be life-threatening to the living object. According to the processing system 10 of the present example embodiment, such an important position can be registered as a registration area commonly applied to all vehicles.

### Fourth Example Embodiment

### Overview

The processing system 10 of the fourth example embodiment embodies the processing system 10 of the second example embodiment. That is, the processing system 10 registers the CO₂ concentration inside the vehicle at that time as a reference value in response to the detection of the suspension event, and updates the reference value to the CO₂ concentration inside the vehicle at that time in response to the subsequent detection of the alighting event. Then, the processing system 10 detects a living object left behind in the vehicle based on the registered reference value. Details will be described below.

### Overall Image

This is similar to the third example embodiment.

### Hardware Configuration

This is similar to the third example embodiment.

### Functional Configuration

Next, a functional configuration of the processing system 10 of the present example embodiment will be described in detail. FIG. 2 illustrates an example of a functional block diagram of the processing system 10. As illustrated, the processing system 10 includes a suspension detection unit 11, a reference value registration unit 12, an abandonment detection unit 13, a storage unit 14, an alighting detection unit 15, and a reference value updating unit 16. The processing system 10 may not include the storage unit 14. In this case, an external device configured to be able to communicate with the processing system 10 includes the storage unit 14.

The suspension detection unit 11 detects a suspension event which involves suspension of the use of the vehicle based on a sensor mounted on the vehicle. The suspension detection unit 11 may detect a suspension event by the method described in the third example embodiment. In addition, the suspension detection unit 11 may detect the parking-related event described in the third example embodiment as a suspension event. That is, in a case where the parking-related event described in the third example embodiment is detected, the suspension detection unit 11 may determine that the suspension event has occurred.

The configuration of the reference value registration unit 12 is similar to the configuration described in the third example embodiment.

The alighting detection unit 15 detects an alighting event which involves alighting from the vehicle based on a sensor mounted on the vehicle.

The “alighting event” includes at least one of the following.
Opening/closing of door of vehicle
Door lock process based on predetermined locking operation for locking door of vehicle from outside of vehicle
Movement of living object in predetermined direction in image generated by camera mounted on vehicle

The “opening/closing of a door of a vehicle” is detected by a door sensor that is mounted on a vehicle and detects opening/closing of the door of the vehicle. The alighting detection unit 15 can detect the event based on the information handled by the in-vehicle system 20.

The “door lock process based on a predetermined locking operation for locking the door of the vehicle from the outside of the vehicle” is a process of locking the door based on an operation on a smart key, a sensor present outside the vehicle (for example, a door knob portion), or the like. The alighting detection unit 15 can detect the event based on the information handled by the in-vehicle system 20.

“Movement of a living object in a predetermined direction in an image generated by a camera mounted on a vehicle” is specified by image analysis. The movement of the living object in the predetermined direction is a movement for alighting from the door of the vehicle. The position of the door of the vehicle in the image generated by the camera and the moving direction for alighting from the vehicle are defined in the image coordinate system and registered in the processing system 10. The camera is mounted on the vehicle at a position and in a direction in which the vicinity of the door of the vehicle is imaged. Then, the camera captures a moving image.

The alighting detection unit 15 analyzes the image generated by the camera and detects a predetermined living object in the image. Then, the alighting detection unit 15 tracks the living object in the image and specifies the moving direction of the living object in the image.

Then, the alighting detection unit 15 determines that an alighting event has occurred in a case where the living object moves in a predefined moving direction for alighting from the vehicle and passes through a predefined position of the door of the vehicle. The condition for detecting abandonment by the image analysis is not limited to this example, and other conditions can be used.

In a case where an alighting event is detected after the suspension event, the reference value updating unit 16 updates the reference value registration united in the storage unit 14 to the CO₂ concentration inside the vehicle at the time the alighting event is detected. As described above, a CO₂ sensor that measures a CO₂ concentration is mounted on the vehicle. The CO₂ sensor measures the CO₂ concentration inside the vehicle at the time an alighting event is detected.

As illustrated in FIG. 8, the vehicle identification information and the reference value are associated with each other and registered in the storage unit 14 by the reference value registration unit 12. The reference value updating unit 16 updates the reference value of each vehicle registered in this manner to the CO₂ concentration inside the vehicle at the time the alighting event is detected.

In a case where the alighting event is repeatedly detected after the suspension event, the reference value updating unit 16 updates the reference value registration united in the storage unit 14 at that time to the CO₂ concentration inside the vehicle at the time the alighting event is newly detected, in response to detection of a new alighting event.

The abandonment detection unit 13 detects a living object left behind in the vehicle by comparing the CO₂ concentration inside the vehicle after the suspension event is detected with the reference value registration united in the storage unit 14 at that time. Until the alighting event is detected, the abandonment detection unit 13 detects a living object left behind in the vehicle based on the reference value registration united by the reference value registration unit 12. Then, after the alighting event is detected, the abandonment detection unit 13 detects a living object left behind in the vehicle based on the reference value updated by the reference value updating unit 16.

Details of the processing by the abandonment detection unit 13 are as described in the third example embodiment.

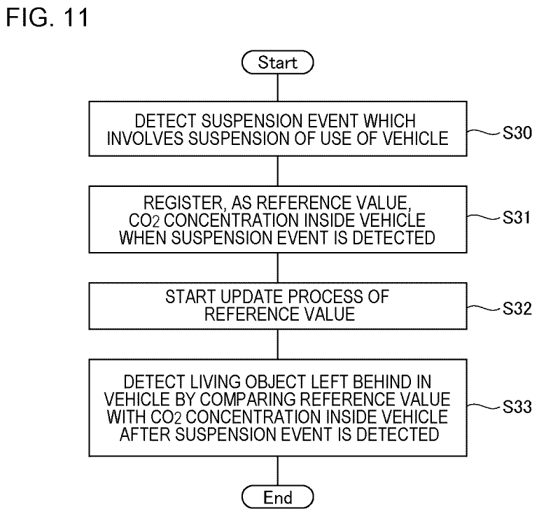

Next, an example of a processing flow of the processing system 10 will be described with reference to a flowchart of FIG. 11.

In a case of detecting a suspension event which involves suspension of the use of the vehicle (S30), the processing system 10 registers the CO₂ concentration inside the vehicle at the time the suspension event is detected as a reference value (S31). Then, the processing system 10 starts an update process of a reference value (S32).

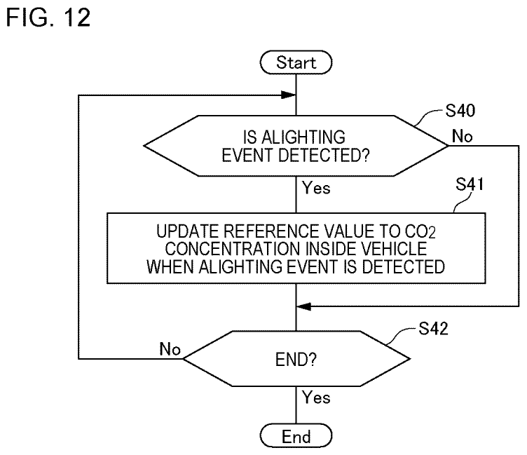

Here, an example of the flow of the update processing of S32 will be described with reference to the flowchart of FIG. 12.

The processing system 10 is waiting for detection of an alighting event (S40). The alighting event includes at least one of opening/closing of a door of the vehicle, a door lock process based on a predetermined locking operation for locking the door of the vehicle from the outside of the vehicle, and movement of a living object in a predetermined direction in an image generated by a camera mounted on the vehicle.

Then, in a case of detecting the alighting event (Yes in S40), the processing system 10 updates the reference value registration united in the storage unit 14 to the CO₂ concentration inside the vehicle at the time the alighting event is detected (S41). Thereafter, the processing system 10 repeats similar processes. That is, in a case where the alighting event is repeatedly detected, the processing system 10 updates the reference value registration united in the storage unit 14 to the CO₂ concentration inside the vehicle at the time the alighting event is detected each time (S41)

Returning to FIG. 11, the processing system 10 detects a living object left behind in the vehicle by comparing the CO₂ concentration inside the vehicle after the suspension event is detected with the reference value registration united in the storage unit 14 at that time (S33).

Specifically, after the suspension event is detected and before the alighting event is detected, the processing system 10 detects a living object left behind in the vehicle based on the reference value registration united in response to the detection of the suspension event as illustrated in FIG. 3. As illustrated in FIG. 3, in a case where a value obtained by subtracting the reference value from the CO₂ concentration inside the vehicle after the suspension event is detected (an increased value of the CO₂ concentration) exceeds a threshold, the processing system 10 determines that a living object is left behind in the vehicle.

Then, after the alighting event is detected, the processing system 10 detects a living object left behind in the vehicle based on the reference value updated in response to the detection of the alighting event as illustrated in FIG. 5. As illustrated in FIG. 5, in a case where a value obtained by subtracting the updated reference value from the CO₂ concentration inside the vehicle after the suspension event is detected (an increased value of the CO₂ concentration) exceeds a threshold, the processing system 10 determines that a living object is left behind in the vehicle.

In a case where a living object left behind in the vehicle is not detected even after a lapse of a predetermined time without detection of the alighting event after detection of the suspension event, the processing system 10 may end the process of detecting a living object left behind in the vehicle in S33.

In a case where the alighting event is detected after the suspension event is detected, and in a case where a living object left behind in the vehicle is not detected even after a lapse of a predetermined time from the latest alighting event, the processing system 10 may end the process of detecting a living object left behind in the vehicle in S33.

The processing system 10 of the present example embodiment may include means for detecting a suspension event based on the position of the vehicle described in the first and third example embodiments.

### Operation and Effect

According to the processing system 10 of the present example embodiment, operations and effects similar to those of the processing system 10 of the first to third example embodiments are achieved.

According to the processing system 10 of the present example embodiment, it is possible to detect an alighting event by a characteristic method and update the reference value according to the detection. By updating the reference value at such an appropriate timing, the problem of suppressing erroneous determination in detection of a living object left behind in the vehicle based on the CO₂ concentration inside the vehicle is solved.

### Fifth Example Embodiment

The processing system 10 of the present example embodiment can make the content of the warning process performed in a case where a living object left behind in the vehicle is detected different according to the situation of the vehicle at that time. Details will be described below.

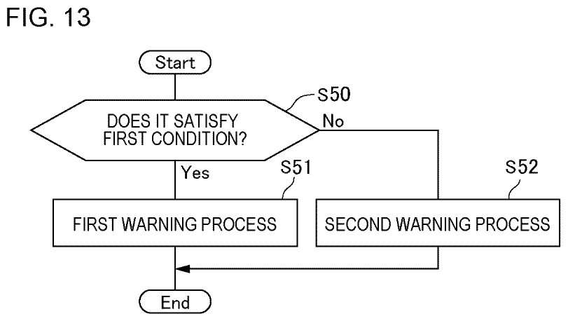

In a case where a living object left behind in the vehicle is detected, the abandonment detection unit 13 executes a first warning process or second warning process according to the situation of the vehicle at that time. A warning process performed by the abandonment detection unit 13 in a case where a living object left behind in the vehicle is detected will be described with reference to a flowchart of FIG. 13.

As illustrated in the flowchart of FIG. 13, in a case where a living object left behind in the vehicle is detected and the situation of the vehicle at that time satisfies a first condition (Yes in S50), the abandonment detection unit 13 executes the first warning process (S51). Then, in a case where a living object left behind in the vehicle is detected and the situation of the vehicle at that time does not satisfy the first condition, the abandonment detection unit 13 executes the second warning process (S52).

The first condition includes at least one of the following:
The temperature inside the vehicle is within a preset danger range
The vehicle door is locked
The position of the vehicle is within a predetermined area
The time is a preset time zone

The abandonment detection unit 13 can specify the “temperature inside the vehicle” based on the measurement value of the temperature sensor mounted on the vehicle. The abandonment detection unit 13 can specify the state of “locking of the door of the vehicle” based on the information handled by the in-vehicle system 20.

The abandonment detection unit 13 can specify the “position of the vehicle” based on a measurement value of a position sensor mounted on the vehicle. The “predetermined area” may be, for example, the registration area described in the second example embodiment or an area designated by the user by another method.

The “preset time zone” may be set by the user. The user can set, for example, a time zone in which the user does not usually use the vehicle in the time zone. In a case where the abandonment of a living object in the vehicle occurs in such a time zone, there is a high possibility that the state is not noticed and the living object is left.

The first warning process and the second warning process are different from each other in the contents of the warning process. The contents of the first warning process performed in a case where the first condition is satisfied have a higher degree of urgency. For example, in the first warning process and the second warning process, at least one of a notification destination, a notification content, and a notification mode may be different from each other.

### Notification Destination

For example, the user registers in advance a notification destination in a case where the first condition is satisfied and a notification destination in a case where the first condition is not satisfied. Since the notification in a case where the first condition is satisfied is more urgent, the user can make the number of notification destinations in a case where the first condition is satisfied larger than the number of notification destinations in a case where the first condition is not satisfied. As an example, it is conceivable to register the contact addresses of the father and the mother as the notification destination in a case where the first condition is not satisfied, and register the contact addresses of the father, the mother, the grandparents, and the relatives as the notification destination in a case where the first condition is satisfied.

### Notification Content

For example, the notification content in a case where the first condition is satisfied may indicate the content of the satisfied first condition in addition to the detection of a living object left behind in the vehicle. The notification content in a case where the first condition is satisfied may further indicate position information of the vehicle where the abandonment has been detected, a date and time at the time the abandonment has been detected, an elapsed time since the suspension event has been detected, a current state inside the vehicle (CO₂ concentration, temperature, etc.), and the like.

On the other hand, the notification content in a case where the first condition is not satisfied may indicate only that a living object left behind in the vehicle has been detected. The notification content in a case where the first condition is not satisfied may include other information such as position information of the vehicle where the abandonment is detected.

### Notification Mode

The notification mode in a case where the first condition is satisfied attracts more attention of the user than the notification mode in a case where the first condition is not satisfied. For example, in a case where the first condition is satisfied, the information to be displayed on the display may be highlighted by blinking or displaying in a more conspicuous color. In addition, in a case where the first condition is satisfied, a warning sound may be output. Then, in a case where the first condition is not satisfied, notification in such a mode may not be performed.

Other configurations of the processing system 10 of the present example embodiment are similar to those of the first to fourth example embodiments.

According to the processing system 10 of the present example embodiment, operations and effects similar to those of the first to fourth example embodiments are achieved.

According to the processing system 10 of the present example embodiment, in a case where a living object left behind in the vehicle is detected, warning process according to the situation of the vehicle at that time can be performed. Specifically, in a case where the degree of urgency is higher, the warning process can be performed by a method suitable for such a situation. By performing the warning process according to the situation of the vehicle, it is expected to suppress a severe accident caused by a living object left behind in the vehicle.

### Sixth Example Embodiment

In a case where a value obtained by subtracting the reference value from the CO₂ concentration inside the vehicle after the suspension event is detected (an increased value of the CO₂ concentration) exceeds a threshold, the processing system 10 of the present example embodiment determines that a living object is left behind in the vehicle. Then, the processing system 10 has means for setting the threshold for each vehicle. Details will be described below.

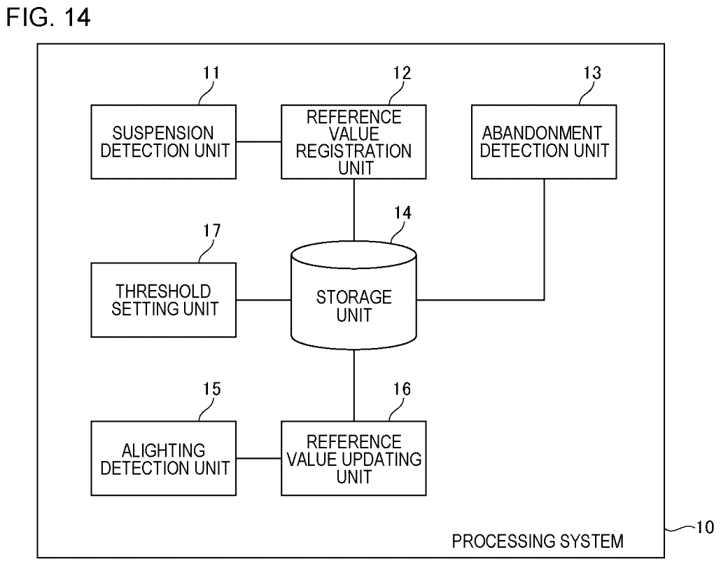

FIG. 14 illustrates an example of a functional block diagram of the processing system 10 of the present example embodiment. As illustrated, the processing system 10 includes a suspension detection unit 11, a reference value registration unit 12, an abandonment detection unit 13, a storage unit 14, an alighting detection unit 15, a reference value updating unit 16, and a threshold setting unit 17. The processing system 10 may not include the storage unit 14. In this case, an external device configured to be able to communicate with the processing system 10 includes the storage unit 14. The processing system 10 may not include the alighting detection unit 15 and the reference value updating unit 16.

Similarly to the first to fifth example embodiments, in a case where a value obtained by subtracting the reference value from the CO₂ concentration inside the vehicle after the suspension event is detected becomes equal to or larger than a threshold, the abandonment detection unit 13 determines that a living object is left in the vehicle.

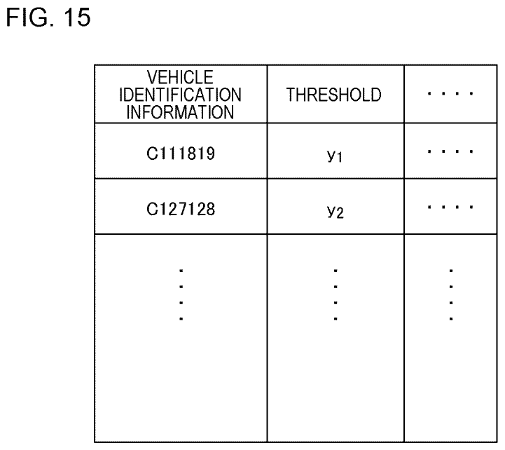

Then, the threshold setting unit 17 sets the threshold based on the attribute information of the vehicle and the occupant information regarding the occupant of the vehicle. Threshold setting unit 17 sets a threshold for each vehicle. Then, the storage unit 14 can store information as illustrated in FIG. 15. FIG. 15 illustrates information in which the vehicle identification information is associated with the threshold.

The “attribute information of the vehicle” includes at least one of a vehicle type and a vehicle name. In the case of the present example embodiment, the attribute information of the vehicle is registered in the processing system 10 in advance for each vehicle as initial setting for receiving the service of the processing system 10. The “vehicle type” is information indicating a body type such as a sedan, a minivan, or an SUV. The approximate size of the vehicle can be specified based on the vehicle type and the vehicle name.

Threshold setting unit 17 sets a smaller threshold as the vehicle is larger. This is because the CO₂ concentration inside the vehicle is less likely to increase as the vehicle is larger and the space inside the vehicle is larger.

There are various ways of setting the threshold with such contents, and there is no particular limitation. For example, reference information defining a threshold for each vehicle type or each vehicle name may be generated in advance and registered in the processing system 10. In this reference information, a smaller threshold is determined as the vehicle is larger.

The threshold setting unit 17 may set the threshold of each vehicle based on the reference information.

The “occupant information” includes age information of the occupant. The age information may be information indicating the age of the occupant. In addition, the age information may indicate a category according to age, such as an infant, a child, an adult, an elderly person, or the like.

The threshold setting unit 17 acquires age information of an occupant of each vehicle. In a case where an occupant of a predetermined age group is included, the threshold setting unit 17 sets a smaller threshold than a case where an occupant of a predetermined age group is not included. The occupant in the predetermined age group is an infant (for example, 6 years old or younger), an elderly person (for example, 80 years old or older), or the like. In a case where such occupants of a predetermined age group are left inside the vehicle, it is considered that the CO₂ concentration inside the vehicle is less likely to increase as compared with a case where occupants of other age groups are left inside the vehicle.

The threshold setting unit 17 can acquire the age information of the occupant of each vehicle by any one of the following first to third acquisition methods. The age information is information serving as a guide indicating the age of the occupant in the vehicle. The age information may be information indicating an age of an occupant who actually gets on the vehicle at that time. In addition, the age information may be information indicating an age of an occupant who tends to get on each vehicle.

### First Acquisition Method

The method is used in a case where an occupant of a vehicle is generally fixed, such as a private car or a school bus. The age information of an occupant who uses each vehicle is registered in advance in the processing system 10 based on a user input. The threshold setting unit 17 acquires the age information of the occupant set based on the user input in this manner and registered in the processing system 10 in association with each vehicle.

### Second Acquisition Method

The method is not limited to a case where an occupant of a vehicle is generally fixed, such as a private car or a school bus, and can also be used in a case where the occupant of the vehicle is different every time, such as a public vehicle (for example, a public bus). In the case of this method, an image of the occupant of the vehicle is captured by a camera mounted at a predetermined location of the vehicle, and the image is analyzed to estimate the age of the occupant. Age estimation by image analysis can be implemented by using any technique.

For example, in a case where the vehicle is a large vehicle such as a bus, a camera may be installed at the entrance of the vehicle. The camera is installed at a position and in a direction in which a person in the vehicle is captured. The threshold setting unit 17 detects a person from the image generated by such a camera and estimates the age of the detected person. Then, the threshold setting unit 17 registers the estimated age as the age information. In a case where a plurality of persons are detected, the threshold setting unit 17 registers estimated ages of the plurality of persons as age information.

### Third Acquisition Method

The method is used in a case where the occupant of the vehicle is different every time, such as a public vehicle (for example, a public bus). The threshold setting unit 17 specifies an age tendency relevant to the traveling characteristic of the vehicle for which the threshold is to be set from information indicating the age tendency of the occupant in the past indicated for at least one traveling characteristic among the month, the day of the week, the time zone, the weather, and the route. The identified age tendency is age information of the occupant of the vehicle.

Information indicating the past age tendency of the occupant for each traveling characteristic is generated in advance and registered in the processing system 10. The threshold setting unit 17 executes the above process based on the information. Means for generating the information indicating the age tendency is not particularly limited, and any technique can be adopted.

Other configurations of the processing system 10 of the present example embodiment are similar to those of the first to fifth example embodiments.

According to the processing system 10 of the present example embodiment, operations and effects similar to those of the first to fifth example embodiments are achieved.

According to the processing system 10 of the present example embodiment, it is possible to appropriately set a threshold for detecting a living object left behind in the vehicle for each vehicle. The way of increasing the CO₂ concentration inside the vehicle (rise speed, rise rate, rise range, etc.) may vary depending on the size of the vehicle (the size of the internal space of the vehicle), the age group of the person who is left behind, and the like. By appropriately setting the threshold for each vehicle, it is possible to accurately detect a living object left behind in the vehicle.

### Modifications

Here, modifications applicable to the first to fifth example embodiments will be described. Also in these modifications, the operations and effects as those of the first to fifth example embodiments are implemented.

### First Modification

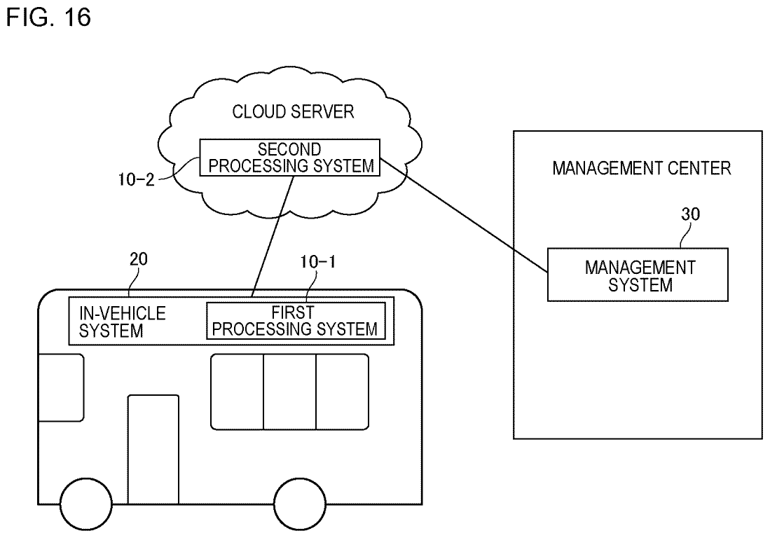

In the example described with reference to FIG. 6 in the third example embodiment, the cloud server includes the processing system 10. In the first modification, as illustrated in FIG. 16, the functions of the processing system 10 are distributed to the cloud server and the in-vehicle system 20. In FIG. 16, the processing system 10 is divided into a first processing system 10-1 and a second processing system 10-2. The in-vehicle system 20 includes the first processing system 10-1, and the cloud server includes the second processing system 10-2.

The first processing system 10-1 includes a part of the functional units (suspension detection unit 11, reference value registration unit 12, abandonment detection unit 13, storage unit 14, alighting detection unit 15, reference value updating unit 16, and threshold setting unit 17) described in the first to fifth example embodiments. Then, the second processing system 10-2 includes other parts of the functional units described in the first to fifth example embodiments.

### Second Modification

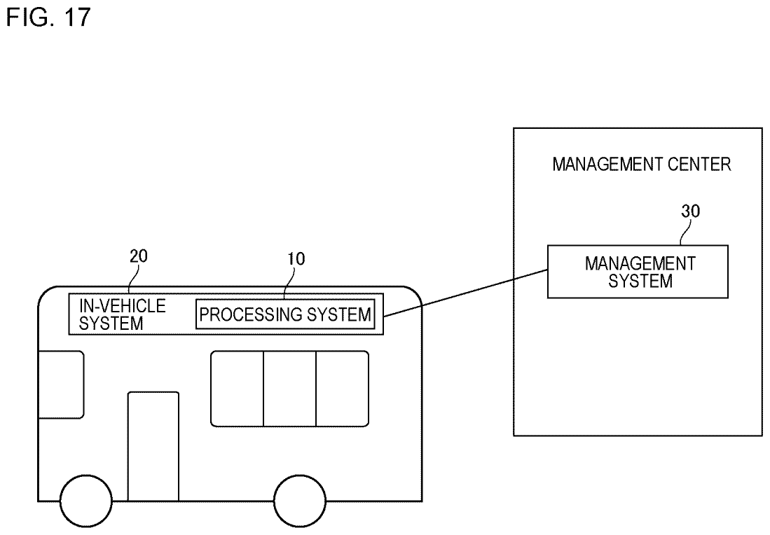

In a second modification, as illustrated in FIG. 17, the function of the processing system 10 is provided in the in-vehicle system 20. In FIG. 17, the in-vehicle system 20 includes a processing system 10. In the case of the modification, the processing system 10 only needs to store information (reference value, threshold, and the like) regarding the mounted vehicle.

### Third Modification

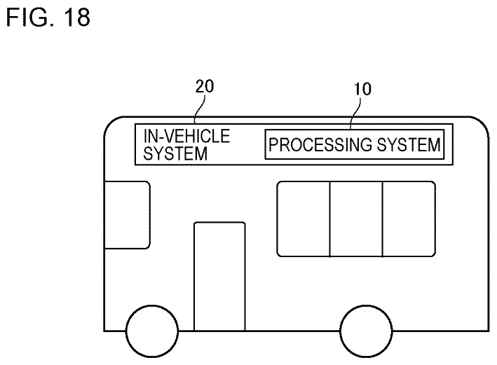

In a third modification, as illustrated in FIG. 18, the function of the processing system 10 is provided in the in-vehicle system 20. In FIG. 18, there is no management system 30. In the third modification, the process is completed only by the in-vehicle system 20 and the processing system 10 mounted on each vehicle. In the case of the modification, the processing system 10 only needs to store information (reference value, threshold, and the like) regarding the mounted vehicle.

Although the example embodiments of the present invention have been described above with reference to the drawings, these are examples of the present invention, and various configurations other than the above can be adopted. The configurations of the above-described example embodiments may be combined with each other, or some configurations may be replaced with other configurations. In addition, various modifications may be made to the configuration of the above-described example embodiments within a range not departing from the scope. In addition, the configurations and processes disclosed in the above-described example embodiments and modifications may be combined with each other.

In the plurality of flowcharts used in the above description, a plurality of steps (processes) are described in order. However, the execution order of the steps executed in each example embodiment is not limited to the described order. In each example embodiment, the order of the illustrated steps can be changed within a range in which there is no problem in content. In addition, the above-described example embodiments can be combined within a range in which the contents are not contradictory.

Some or all of the above example embodiments may be described as the following Supplementary Notes, but are not limited to the following.
1. A processing system including:
a suspension detection means for detecting a suspension event, which involves suspension of a use of a vehicle, based on a sensor mounted on the vehicle;
a reference value registration means for registering, as a reference value, a CO₂ concentration of an inside of the vehicle at a time of detection of the suspension event;
an alighting detection means for detecting an alighting event, which involves alighting from the vehicle, based on a sensor mounted on the vehicle;
a reference value updating means for, in a case where the alighting event is detected after the suspension event, updating the registered reference value to a CO₂ concentration of an inside of the vehicle at a time of detection of the alighting event; and
an abandonment detection means for detecting a living object left behind in the vehicle by comparing the reference value with a CO₂ concentration of an inside of the vehicle after the suspension event is detected.
2. The processing system according to 1, in which the suspension detection means detects, as the suspension event, an event including at least one of an engine stop process of the vehicle, a power-off process of the vehicle, a door lock process based on a predetermined lock operation for locking a door of the vehicle from outside the vehicle, an event in which a position of the vehicle does not change for a predetermined time or more, and absence of a person in a driver's seat is detected.
3. The processing system according to 1 or 2, in which the alighting detection means detects the alighting event including at least one of opening/closing of a door of the vehicle, a door lock process based on a predetermined lock operation of locking a door of the vehicle from outside of the vehicle, and movement of a living object in a predetermined direction in an image generated by a camera mounted on the vehicle.
4. The processing system according to any one of 1 to 3, in which
the abandonment detection means determines that, in a case where a value obtained by subtracting the reference value from a CO₂ concentration inside the vehicle after the suspension event is detected is equal to or greater than a threshold, a living object is left behind in the vehicle, and
the processing system comprises a threshold setting means for setting the threshold based on attribute information of the vehicle and occupant information related to an occupant of the vehicle.
5. The processing system according to 4, in which
attribute information of the vehicle includes at least one of a vehicle type and a vehicle name, and
the threshold setting means sets the threshold smaller as the vehicle is larger.
6. The processing system according to 4 or 5, in which
the occupant information includes age information of an occupant, and
the threshold setting means sets the threshold smaller in a case where an occupant of a predetermined age group is included than in a case where an occupant of the predetermined age group is not included.
7. The processing system according to 6, in which
the vehicle is a public vehicle, and
the threshold setting means specifies an age tendency relevant to the traveling characteristic of the vehicle to which the threshold is set from information indicating an age tendency of a past occupant indicated for at least one traveling characteristic among a month, a day of the week, a time zone, weather, and a route, and sets the threshold based on a specified age tendency.
8. The processing system according to 6, in which the occupant information indicates an age estimated by image analysis of an occupant detected in an image generated by a camera mounted on the vehicle.
9. The processing system according to 6, in which the occupant information includes age information of an occupant who uses the vehicle set based on a user input.
10. A processing method for causing a computer to execute:
detecting a suspension event, which involves suspension of a use of a vehicle, based on a sensor mounted on the vehicle;
registering, as a reference value, a CO₂ concentration of an inside of the vehicle at a time of detection of the suspension event;
detecting an alighting event, which involves alighting from the vehicle, based on a sensor mounted on the vehicle;
updating, in a case where the alighting event is detected after the suspension event, the registered reference value to a CO₂ concentration of an inside of the vehicle at a time of detection of the alighting event; and
detecting a living object left behind in the vehicle by comparing the reference value with a CO₂ concentration of an inside of the vehicle after the suspension event is detected.
11. A recording medium storing a program causing a computer to function as:
a suspension detection means for detecting a suspension event, which involves suspension of a use of a vehicle, based on a sensor mounted on the vehicle;

a reference value registration means for registering, as a reference value, a CO₂ concentration of an inside of the vehicle at a time of detection of the suspension event;
an alighting detection means for detecting an alighting event, which involves alighting from the vehicle, based on a sensor mounted on the vehicle;
a reference value updating means for, in a case where the alighting event is detected after the suspension event, updating the registered reference value to a CO₂ concentration of an inside of the vehicle at a time of detection of the alighting event; and
an abandonment detection means for detecting a living object left behind in the vehicle by comparing the reference value with a CO₂ concentration of an inside of the vehicle after the suspension event is detected.

### REFERENCE SIGNS LIST

10 processing system
11 suspension detection unit
12 reference value registration unit
13 abandonment detection unit
14 storage unit
15 alighting detection unit
16 reference value updating unit
17 threshold setting unit
1A processor
2A memory
3A input/output I/F
4A peripheral circuit
5A bus

What is claimed is:

1. A processing system comprising:
at least one memory configured to store one or more instructions; and
at least one processor configured to execute the one or more instructions to:
detect a suspension event, which involves suspension of a use of a vehicle, based on a sensor mounted on the vehicle;
register, as a reference value, a CO₂ concentration of an inside of the vehicle at a time of detection of the suspension event;
detect an alighting event, which involves alighting from the vehicle, based on a sensor mounted on the vehicle;
in a case where the alighting event is detected after the suspension event, update the registered reference value to a CO₂ concentration of an inside of the vehicle at a time of detection of the alighting event; and
detect a living object left behind in the vehicle by comparing the reference value with a CO₂ concentration of an inside of the vehicle after the suspension event is detected.

2. The processing system according to claim 1, wherein the at least one processor is further configured to execute the one or more instructions to detect, as the suspension event, an event including at least one of an engine stop process of the vehicle, a power-off process of the vehicle, a door lock process based on a predetermined lock operation for locking a door of the vehicle from outside the vehicle, an event in which a position of the vehicle does not change for a predetermined time or more, and absence of a person in a driver's seat is detected.

3. The processing system according to claim 1, wherein the at least one processor is further configured to execute the one or more instructions to detect the alighting event including at least one of opening/closing of a door of the vehicle, a door lock process based on a predetermined lock operation of locking a door of the vehicle from outside of the vehicle, and movement of a living object in a predetermined direction in an image generated by a camera mounted on the vehicle.

4. The processing system according to claim 1, wherein the at least one processor is further configured to execute the one or more instructions to:
determine that, in a case where a value obtained by subtracting the reference value from a CO₂ concentration inside the vehicle after the suspension event is detected is equal to or greater than a threshold, a living object is left behind in the vehicle, and
set the threshold based on attribute information of the vehicle and occupant information related to an occupant of the vehicle.

5. The processing system according to claim 4, wherein:
attribute information of the vehicle includes at least one of a vehicle type and a vehicle name, and
the at least one processor is further configured to execute the one or more instructions to set the threshold smaller as the vehicle is larger.

6. The processing system according to claim 4, wherein:
the occupant information includes age information of an occupant, and
the at least one processor is further configured to execute the one or more instructions to set the threshold smaller in a case where an occupant of a predetermined age group is included than in a case where an occupant of the predetermined age group is not included.

7. The processing system according to claim 6, wherein:
the vehicle is a public vehicle, and
the at least one processor is further configured to execute the one or more instructions to specify an age tendency relevant to the traveling characteristic of the vehicle to which the threshold is set from information indicating an age tendency of a past occupant indicated for at least one traveling characteristic among a month, a day of the week, a time zone, weather, and a route, and sets the threshold based on a specified age tendency.

8. The processing system according to claim 6, wherein the occupant information indicates an age estimated by image analysis of an occupant detected in an image generated by a camera mounted on the vehicle.

9. The processing system according to claim 6, wherein the occupant information includes age information of an occupant who uses the vehicle set based on a user input.

10. A processing method for causing a computer to execute:
detecting a suspension event, which involves suspension of a use of a vehicle, based on a sensor mounted on the vehicle;
registering, as a reference value, a CO₂ concentration of an inside of the vehicle at a time of detection of the suspension event;
detecting an alighting event, which involves alighting from the vehicle, based on a sensor mounted on the vehicle;
updating, in a case where the alighting event is detected after the suspension event, the registered reference value to a CO₂ concentration of an inside of the vehicle at a time of detection of the alighting event; and
detecting a living object left behind in the vehicle by comparing the reference value with a CO₂ concentration of an inside of the vehicle after the suspension event is detected.

11. A non-transitory computer-readable medium storing a program causing a computer to as:
detect a suspension event, which involves suspension of a use of a vehicle, based on a sensor mounted on the vehicle;
register, as a reference value, a CO₂ concentration of an inside of the vehicle at a time of detection of the suspension event;
detect an alighting event, which involves alighting from the vehicle, based on a sensor mounted on the vehicle;
in a case where the alighting event is detected after the suspension event, update the registered reference value to a CO₂ concentration of an inside of the vehicle at a time of detection of the alighting event; and
detect a living object left behind in the vehicle by comparing the reference value with a CO₂ concentration of an inside of the vehicle after the suspension event is detected.

12. The processing method according to claim 10, wherein the computer detects, as the suspension event, an event including at least one of an engine stop process of the vehicle, a power-off process of the vehicle, a door lock process based on a predetermined lock operation for locking a door of the vehicle from outside the vehicle, an event in which a position of the vehicle does not change for a predetermined time or more, and absence of a person in a driver's seat is detected.

13. The processing method according to claim 10, wherein the computer detects the alighting event including at least one of opening/closing of a door of the vehicle, a door lock process based on a predetermined lock operation of locking a door of the vehicle from outside of the vehicle, and movement of a living object in a predetermined direction in an image generated by a camera mounted on the vehicle.

14. The processing method according to claim 10, wherein:
the computer determines that, in a case where a value obtained by subtracting the reference value from a CO₂ concentration inside the vehicle after the suspension event is detected is equal to or greater than a threshold, a living object is left behind in the vehicle, and
the computer sets the threshold based on attribute information of the vehicle and occupant information related to an occupant of the vehicle.

15. The processing method according to claim 14, wherein:
attribute information of the vehicle includes at least one of a vehicle type and a vehicle name, and
the computer sets the threshold smaller as the vehicle is larger.

16. The processing method according to claim 14, wherein:
the occupant information includes age information of an occupant, and
the computer sets the threshold smaller in a case where an occupant of a predetermined age group is included than in a case where an occupant of the predetermined age group is not included.

17. The non-transitory computer-readable medium according to claim 11, wherein the program causing the computer to detect, as the suspension event, an event including at least one of an engine stop process of the vehicle, a power-off process of the vehicle, a door lock process based on a predetermined lock operation for locking a door of the vehicle from outside the vehicle, an event in which a position of the vehicle does not change for a predetermined time or more, and absence of a person in a driver's seat is detected.

18. The non-transitory computer-readable medium according to claim 11, wherein the program causing the computer to detect the alighting event including at least one of opening/closing of a door of the vehicle, a door lock process based on a predetermined lock operation of locking a door of the vehicle from outside of the vehicle, and movement of a living object in a predetermined direction in an image generated by a camera mounted on the vehicle.

19. The non-transitory computer-readable medium according to claim 11, wherein the program causing the computer to-to:
determine that, in a case where a value obtained by subtracting the reference value from a CO₂ concentration inside the vehicle after the suspension event is detected is equal to or greater than a threshold, a living object is left behind in the vehicle, and
set the threshold based on attribute information of the vehicle and occupant information related to an occupant of the vehicle.

20. The non-transitory computer-readable medium according to claim 19, wherein wherein:
attribute information of the vehicle includes at least one of a vehicle type and a vehicle name, and
the program causing the computer to set the threshold smaller as the vehicle is larger.
